(19) United States
(12) Patent Application Publication
(10) Pub. No.: US 2011/0161791 A1
(43) Pub. Date: Jun. 30, 2011

(54) METHOD AND SYSTEM FOR NOTIFICATION OF RECENT ACTIVITY ON A WEBSITE

(76) Inventors: Amy D. Travis, (US); Sara Weber, (US); James P. Galvin, JR., (US)

(21) Appl. No.: 12/650,784

(22) Filed: Dec. 31, 2009

(51) Int. Cl. G06F 15/173; G06F 3/01; G06F 15/16; G06F 17/00

(52) U.S. Cl. 715/205; 709/224; 715/747; 709/206

(57) ABSTRACT

It may be detected that a user of a communication application engages in an activity on a website. User preferences of the user then may be applied. If it is allowed by the user preferences, the fact that the user has engaged in the activity may be communicated to a process running on a computing device of at least one other user of the communication application. A list of one or more member identifiers may be generated on a computer display of the computing device. If allowed by user preferences of the user, a notification indicative of the recent activity engaged in by the member is generated on the computer display such that the notification is associated with at least one member identifier of the one or more member identifiers corresponding to the user.

### BACKGROUND

This disclosure relates to activity on a website and, more particularly, to notification of a user's recent activity on a website to others within the user's social network.

Many computer users communicate and share information by posting information to websites, such as blogs, social networking sites, newsgroups, and other similar content providers. Websites like the social networking Facebook® site and the Blogger® site allow users to post and share information. These sites typically allow users to post and publish any type of information, such as personal information and statuses, information about an industry, political commentary, etc. Some companies also maintain internal websites similar to social networking or blogging sites, which allow a user to post information in order to make the information available to other employees or groups within the company.

Websites like social networking and blogging sites typically allow a user to engage in any of a variety of activities, including posting a variety of types of information. A user may, for example, post a blog entry or respond to a blog, add or update content in a wiki, join a community, post a file in a shared repository, post comments on a file, update a profile, or post information or content on a social networking site. When the user engages in such activity, information resulting from such activity (e.g., the posting of the information) and/or the mere fact that the user engaged in such activity may become publicly available on the sites.

### BRIEF SUMMARY

In some embodiments, a computer program product resides on a computer-readable memory, having a plurality of instructions, which, when executed by a processor, cause the processor to perform the following operations. A list of one or more member identifiers is generated on a computer display. For a member associated with at least one member identifier in the list of one or more member identifiers, if allowed by user preferences of the member, a notification indicative of a recent activity engaged in by the member on a website is generated on the computer display such that the notification is associated with the at least one member identifier.

In some aspects of such embodiments, the operations may further include, for the at least one member identifier, detecting if the member has engaged in any recent activity on a website. If it is detected that the member has engaged in any recent activity on the website, the user preferences of the member are applied.

In some aspects of such embodiments, the user preferences may specify any of the following and any combination thereof: one or more members and/or groups of members allowed to receive the notification; one or more websites for which a notification should be generated; and one or more types of activities for which a notification should be generated.

In some aspects of such embodiments, the list of member identifiers may include any of the following and any suitable combination thereof: an instant messaging buddy list providing a notification of whether the member is currently online; an email contact list; and an address book.

In some aspects of such embodiments, the operations further may include interpreting a presence document of the member, the presence document including data indicating whether the member engaged in recent activity on a website.

In some aspects of such embodiments, generating the notification may include either or both of the following: displaying at least a portion of content posted to the website by the member; and displaying a link to the website or a particular location therein.

In some aspects of such embodiments, generating the list may include associating a respective icon with the at least one member identifier. Further, if it is detected that the member has engaged in any recent activity on the website, generating the notification may include changing a visual attribute of the icon associated with the at least one member identifier.

In some embodiments, a computer-implemented method includes generating a list of one or more member identifiers on a computer display. For a member associated with at least one member identifier in the list of one or more member identifiers, if allowed by user preferences of the member, a notification indicative of a recent activity engaged in by the member on a website is generated on the computer display such that the notification is associated with the at least one member identifier.

In some embodiments, a computer program product resides on a computer-readable memory, having a plurality of instructions, which, when executed by a processor, causes the processor to perform the following operations. A list of one or more member identifiers is generated on a computer display. For a member associated with at least one member identifier in the list of one or more member identifiers, if allowed by user preferences of the member, a notification indicative of a recent activity engaged in by the member on a website is generated on the computer display such that the notification is associated with the at least one member identifier.

In some aspects of such embodiments, for the at least one member identifier, it is detected if the member has engaged in any recent activity on a website. If it is detected that the member has engaged in any recent activity on the website, the user preferences of the member are applied.

In some aspects of such embodiments, the user preferences may specify any of the following and any combination thereof: one or more members and/or groups of members allowed to receive the notification; one or more websites for which a notification should be generated; and one or more types of activities for which a notification should be generated.

In some aspects of such embodiments, the list of member identifiers may include any of the following and any suitable combination thereof: an instant messaging buddy list providing a notification of whether the member is currently online; an email contact list; and an address book.

In some aspects of such embodiments, a presence document of the member is interpreted, the presence document including data indicating whether the member engaged in recent activity on a website.

In some aspects of such embodiments, generating the notification may include either or both of the following: displaying at least a portion of content posted to the website by the member; and displaying a link to the website or a particular location therein.

In some aspects of such embodiments, generating the list may include associating a respective icon with the at least one member identifier. Further, if it is detected that the member has engaged in any recent activity on the website, generating the notification may include changing a visual attribute of the icon associated with the at least one member identifier.

In some embodiments, a system includes a processor, a memory coupled to the processor, a display, and computer instructions stored on the memory, which, when executed by the processor, cause the processor to perform the following operations. A list of one or more member identifiers is generated on a computer display. For a member associated with at least one member identifier in the list of one or more member identifiers, if allowed by user preferences of the member, a notification indicative of a recent activity engaged in by the member on a website is generated on the computer display such that the notification is associated with the at least one member identifier.

In some aspects of such embodiments, the operations may further include, for the at least one member identifier, detecting if the member has engaged in any recent activity on a website. If it is detected that the member has engaged in any recent activity on the website, the user preferences of the member are applied.

In some aspects of such embodiments, the user preferences may specify any of the following and any combination thereof: one or more members and/or groups of members allowed to receive the notification; one or more websites for which a notification should be generated; and one or more types of activities for which a notification should be generated.

In some aspects of such embodiments, the list of member identifiers may include any of the following and any suitable combination thereof: an instant messaging buddy list providing a notification of whether the member is currently online; an email contact list; and an address book.

In some aspects of such embodiments, the operations further may include interpreting a presence document of the member, the presence document including data indicating whether the member engaged in recent activity on a website.

In some aspects of such embodiments, generating the notification may include either or both of the following: displaying at least a portion of content posted to the website by the member; and displaying a link to the website or a particular location therein.

In some aspects of such embodiments, generating the list may include associating a respective icon with the at least one member identifier. Further, if it is detected that the member has engaged in any recent activity on the website, generating the notification may include changing a visual attribute of the icon associated with the at least one member identifier.

In some embodiments, a computer program product resides on a computer-readable memory, having a plurality of instructions, which, when executed by a processor, cause the processor to perform the following operations. It is detected that a user of a communication application engages in an activity on a website. User preferences of the user are applied. If it is allowed by the user preferences, the fact that the user has engaged in the activity is communicated to a process running on a computing device of at least one other user of the communication application.

In some aspects of such embodiments, the operations include generating a list of one or more member identifiers on a computer display of the computing device. If allowed by the user preferences of the user, a notification indicative of the recent activity engaged in by the user is generated on the computer display such that the notification is associated with at least one member identifier of the one or more member identifiers corresponding to the user.

In some aspects of such embodiments, the operations include recording that the user has engaged in an activity in a presence document of the user. Applying and communicating may be performed by a server of an instant messaging application, and communicating may include communicating at least a portion of content on the website resulting from the user engaging in the activity.

In some aspects of such embodiments, the user preferences may specify any of the following and any combination thereof: one or more members and/or groups of members allowed to receive the notification; one or more websites for which a notification should be generated; and one or more types of activities for which a notification should be generated.

In some embodiments, a computer-implemented method includes detecting that a user of a communication application engages in an activity on a website, and applying user preferences of the user. Further, if allowed by the user preferences, the fact that the user has engaged in the activity is communicated to a process running on a computing device of at least one other user of the communication application.

In some aspects of such embodiments, a list of one or more member identifiers may be generated on a computer display of the computing device. If allowed by user preferences of the user, a notification indicative of the recent activity engaged in by the member is generated on the computer display such that the notification is associated with at least one member identifier of the one or more member identifiers corresponding to the user.

In some aspects of such embodiments, the fact that the user engaged in an activity may be recorded in a presence document of the user. Applying and communicating may be performed by a server of an instant messaging application, and communicating may include communicating at least a portion of content on the website resulting from the user engaging in the activity.

In some aspects of such embodiments, the user preferences may specify any of the following and any combination thereof: one or more members and/or groups of members allowed to receive the notification; one or more websites for which a notification should be generated; and one or more types of activities for which a notification should be generated.

In some embodiments, a system includes a processor, a memory coupled to the processor, a display, and computer instructions stored on the memory, which, when executed by the processor, cause the processor to perform the following operations. It is detected that a user of a communication application engages in an activity on a website. User preferences of the user are applied. If it is allowed by the user preferences, the fact that the user has engaged in the activity is communicated to a process running on a computing device of at least one other user of the communication application.

In some aspects of such embodiments, the operations include generating a list of one or more member identifiers on a computer display of the computing device. If allowed by the user preferences of the user, a notification indicative of the recent activity engaged in by the user is generated on the computer display such that the notification is associated with at least one member identifier of the one or more member identifiers corresponding to the user.

In some aspects of such embodiments, the operations include recording that the user engaged in an activity in a presence document of the user. Applying and communicating may be performed by a server of an instant messaging application, and communicating may include communicating at least a portion of content on the website resulting from the user engaging in the activity.

In some aspects of such embodiments, the user preferences may specify any of the following and any combination thereof: one or more members and/or groups of members allowed to receive the notification; one or more websites for which a notification should be generated; and one or more types of activities for which a notification should be generated.

### BRIEF DESCRIPTION OF THE SEVERAL VIEWS OF THE DRAWINGS

FIG. 1 is diagrammatic view illustrating an example of a computing infrastructure including an activity notification process.

FIG. 2 is a flow chart diagram illustrating an example of an activity notification process.

FIG. 3a is a pictorial diagram illustrating an example of a list of member identifiers.

FIG. 3b is a pictorial diagram illustrating an example of a list of member identifiers.

FIG. 3c is a pictorial diagram illustrating an example of a list of member identifiers.

Like reference numerals in the drawings may denote like elements.

### DETAILED DESCRIPTION

The function and advantage of the above embodiments and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising,” “including,” “carrying” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases, as set forth, with respect to claims, in the United States Patent Office Manual of Patent Examining Procedures (Eighth Edition, Latest Revision, July 2008), Section 2111.03.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Note that the computer-readable storage medium could even be paper or another suitable medium upon which a program is printed, as the program can be electronically captured, via, for instance, optical scanning of the paper or other medium, then compiled, interpreted, or otherwise processed in a suitable manner, if necessary, and then stored in a computer memory. In the context of this document, a computer-readable storage medium may be any medium that can contain or store a program for use by or in connection with an instruction execution system, apparatus, or device.

A computer-readable signal medium may include a propagated data signal with computer-usable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can contain, communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc.

Computer program code for carrying out operations of the present invention may be written in any of a variety of types of programming languages such as, for example, object-oriented programming languages (e.g., Java, Smalltalk, C++ or the like), procedural programming languages (e.g., C, Pascal or the like), scripting languages (e.g., Perl or the like), compiler-based languages, interpreted languages, or any suitable combinations of the foregoing. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

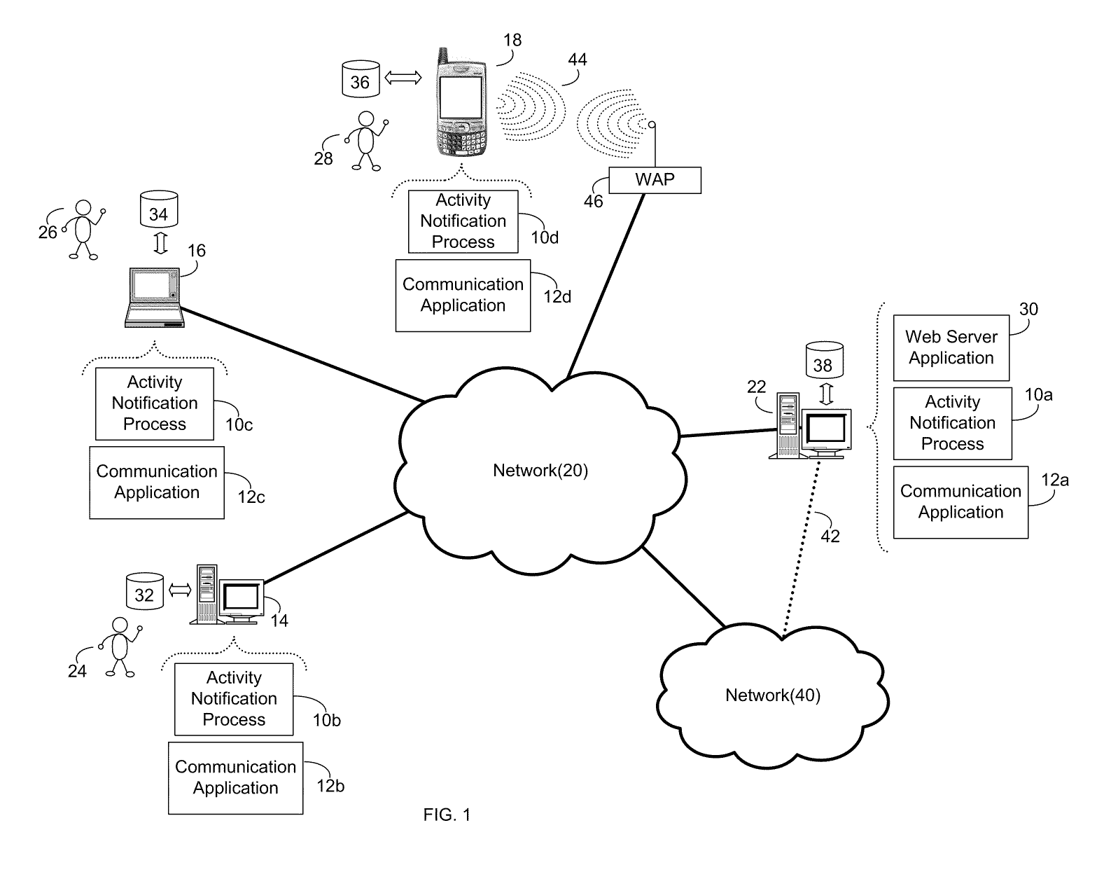

FIG. 1 depicts an illustrative example of a computing infrastructure within which activity notification process 10a-10d and/or communication application 12a-12d may reside. Activity notification process 10b, 10c, 10d, for example, may reside on and may be executed by computer 14, laptop 16, and/or personal digital assistant (“PDA”) 18, respectively, and communication application 12b, 12c, 12d may reside on and be executed by computer 12, laptop 16, and/or PDA 18, respectively, each of which may be directly or indirectly connected to network 20 (e.g., the Internet or a local area network).

Computer 14, laptop 16, and PDA 18 may be end-user devices. Computer 14, laptop 16, and PDA 18 may run network operating systems, examples of which may include but are not limited to: Microsoft Windows XP®; Novell® Netware®; or Redhat® Linux®, for example.

FIG. 1 also shows server 22. Server 22 may be a server computer, such as a web server, blog server, email server, instant messaging server, a server of a communications application, a notification process server, other type of server, or any suitable combination of the foregoing that provides services to users 24, 26, 28, for example. Server 22 may execute web server application 30, which may be a web server hosting a social networking site, a blogging site, or the like. Server 22 may also execute any other type of server application that provides services to users 24, 26, 28, such as an FTP server application, a routing application, a file server application, and the like. Server 22 may also execute a network operating system, examples of which include, but are not limited to: Microsoft Windows XP; Windows XP Server; Novell Netware; or Redhat Linux, for example. Examples of server 22 may include, but are not limited to: a personal computer, a server computer, a series of server or personal computers, a mini computer, and a mainframe computer, for example. Server 22 may also execute activity notification process 10a and/or communication application 12a.

References herein to “activity notification process 10a-10d,” “communication application 12a-12d,” or the like (i.e., in the singular tense) performing functions or actions or having certain structural or functional characteristics should not be construed as requiring that all such processes 10a-10d or applications 12a-12d are required to perform such functions or actions or have such structural or functional characteristics. Rather, such references mean that at least one of such processes or applications, independently or in combination with other such processes or applications, performs such functions or actions or has such structural or functional characteristics.

As will be discussed below in greater detail, activity notification process 10a-10d and/or communications application 12a-12d may generate a list of member identifiers on a computer display. In some embodiments, such a list may be generated by communication application 12a-12d. Activity notification process 10a-10d and/or communications application 12a-12d may also detect, for a member identifier in the list of member identifiers, whether a member associated with the member identifier has engaged in any recent activity on a website and, if the member has engaged in any recent activity on a website, activity notification process 10a-10d and/or communications application 12a-12d may generate an notification indicative of the recent activity on the computer display. For example, such notification may be communicated to communication application 12a-12d.

The instruction sets and subroutines of activity notification process 10a-10d, which may include one or more software modules and one or more sets of software instructions, may be stored on storage device 32 coupled to computer 14, storage device 34 coupled to laptop 16, storage device 36 coupled to PDA 18 and/or storage device 38 coupled to server computer 22. Activity notification process 10a-10d may be executed by one or more processors (not shown) and one or more memory architectures (not shown) incorporated into the various electronic devices. Storage devices 32, 34, 36, 38 may include but are not limited to: hard disk drives; solid state drives; tape drives; optical drives; RAID arrays; random access memory (RAM); and a read-only memory (ROM).

The instruction sets and subroutines of activity notification process 10a-10d may be generated through the use of a compiler, such as the IBM XL compiler, the Visual Studio® compiler, or an assembler, for example. The instruction sets and subroutines may also be generated as scripts, such as JavaScript® scripts, or as other types of software code. In general, and as is known in the art, the instruction sets and subroutines of activity notification process 10a-10d may be generated via any method of generating instruction sets and subroutines that may be executed by a processor.

Server 22, computer 12, laptop 16, and PDA 18 may execute communication application 12a, 12b, 12c, 12d, respectively. Communication application 12a-12d may be an application for communication between users. Communication application 12a-12d may also include or display a contact list or buddy list of contacts with which a user may wish to communicate. Examples of communication application 12a-12d include, but are not limited to: an instant messaging application (e.g., IBM® Lotus® Sametime®), a video conferencing application, an audio messaging application, an email application, a blog reader application, or any other communication application that a user may use to communicate with other users.

As mentioned, various client electronic devices may be coupled to network 20. Examples of client electronic devices may include, but are not limited to: server 22, computer 16, PDA 18, laptop 20, a data-enabled, cellular telephone (not shown), and a dedicated network device (not shown). One or more users (e.g., users 24, 26, 28) may access the various tools and applications, such as activity notification process 10a-10d, communication application 12a-12d, and web server application 30, from any device connected to network 20 or directly from the device on which the tool or application resides.

Various computer devices and/or client electronic devices may be coupled directly to network 20, or may be indirectly coupled to network 20 through network 40. For example, server 22 may be indirectly connected to network 20 through secondary network 40, as illustrated by phantom link line 42.

The various client electronic devices may be directly, indirectly, and/or wirelessly coupled to network 20 (or network 40). For example, server 22, computer 14, and laptop 16 are shown directly coupled to network 20 via a hardwired network connections. PDA 18 is shown wirelessly coupled to network 20 via wireless communication channel 44 established between laptop 20 and wireless access point (i.e., WAP) 46, which is shown directly coupled to network 20. WAP 46 may be, for example, an IEEE 802.11a, 802.11b, 802.11g, Wi-Fi, and/or Bluetooth device that is capable of establishing wireless communication channel 44 between PDA 18 and WAP 46.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

FIG. 1 is merely an illustrative embodiment of a computing infrastructure within which an activity notification process and/or communication application may reside. Such an illustrative embodiment is not intended to limit the scope of the invention, as any of numerous other implementations of an infrastructure; for example, variations of the infrastructure depicted in FIG. 1, are possible and are intended to fall within the scope of the invention. None of the claims set forth below are intended to be limited to any particular implementation of such an infrastructure unless such claim explicitly recites such a limitation. For example, activity notification process 10a-10d may be integrated with communication application 12a-12d, for example, into one or more integral components. Further, each of activity notification process 10a-10d and communication application 12a-12d may be divided into multiple discrete components, and/or may include one or more discrete sub-components, each of which may be distributed across multiple elements of the infrastructure illustrated in FIG. 1. Using activity notification process 10a and communication application 12a as an example, activity notification processes 10a may be integrated with communication application 12a into one or more integral components, some or all of which may be executed by server 22 and/or another computing device. Additionally/alternatively, activity notification process 10a may be executed by a separate computing device than that of communication application 12a. In another example, activity notification process 10a and/or communication application 12a may be divided into multiple discrete components, each of which may be executed by server 22 and/or another computing device.

In some embodiments, activity notification process 10a-10d may be a sub-component of communication application 12a-12d. For example, communication application 12a-12d may be an instant messaging application, and activity notification process 10a-10d may exchange information or be integrated with a sub-component of the instant messaging application that displays a buddy list.

In some embodiments, a given communication application has client and server components that communicate with each other, each of which may reside on different machines. For example, the client may reside on device 14, 16 or 18 and the server may reside on device 22. In such embodiments, the activity notification process may be part of the client or server portion of the application and/or may be independent of the communication application. For example, the communication application may be an instant messaging application, in which the client communicates with one or more servers (e.g., a presence (awareness) server) to determine the presence of one or more users, and such presence server may have access to a presence document. As will be described further below, in such embodiments, the presence server, which may interpret the presence document, may communicate the user's website activity, including or limited to recent activity, to the client. The presence document itself may include user preferences for the user, such that interpreting the presence document may include applying the user preferences. In some embodiments, one or more (e.g., all) user preferences may be stored independently of the presence document such that applying the user preferences is performed independently of the interpretation of the presence document, either in whole or in part.

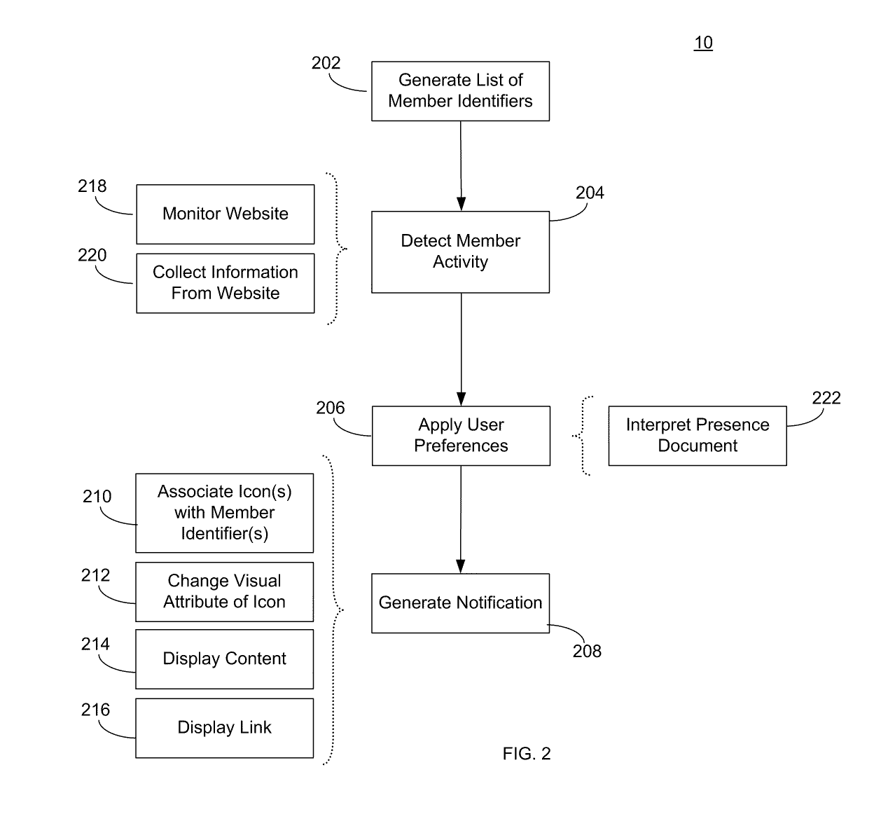

Referring to FIG. 2, communication application 12a-12d or activity notification process 10a-10d may generate 202 a list of member identifiers on a computer display. The list of member identifiers may be stored in a file, such as a text file, xml file, etc., or may be in a data structure, such as a class or struct stored in memory, for example. The list of member identifiers may also be displayed on a computer display. For example, the list of member identifiers may be displayed as, or included in, a buddy list that includes and/or displays users of an instant messaging system. For example, communication application 12a-12d may display a buddy list that includes at least part of the list of member identifiers. To further illustrate the example, assume user 24 (FIG. 1) communicates with other users via an instant messenger program (e.g., communication application 12b). User 24 may enter user 26 and user 28 as friends (e.g., “buddies” or “contacts”) in the instant messaging program. Activity notification process 10b may generate 202 a list of member identifiers that includes member identifiers for users 26 and 28. Activity notification process 10b may store the list of member identifiers as a file on a hard drive (e.g., storage device 32), or may store or load the list of member identifiers into memory. When user 24 runs the communication application 12b, user 24 may see the list of member identifiers included in or incorporated in user 24's buddy list, for example. The buddy list may include user 26 and user 28, and may alert user 24 of user 26's and user 28's status. The buddy list may, for example, list whether user 26 or user 28 is online, offline, busy, in a meeting, available, etc.

In some embodiments, Act 202 may be performed in response to a user (e.g., 24, 26 or 28) logging into a communications application, for example, an instant messaging application. For example, in response to a user logging in, communication application 12b-12d may communicate with a presence server (e.g., on server 22) and/or one or more other servers to determine the presence status of one or more members. Further, it should be appreciated that Acts 204, 206, 207 and 208 (described below in more detail) may be performed a plurality of times following the performance of Act 202, for example, as long as the user remains logged-in. In this context, the successive performances of Act 208 may be considered an updating of an already existing notification.

Although this disclosure uses the term buddy list, one skilled in the art will recognize that generating 202 a list of member identifiers need not be limited to generating 202 a list of users in an instant messaging system or buddy list. For example, a buddy list may include a list of contacts stored in a file, a list of contacts stored in memory, a list of email contacts, an address book, a list of video chat contacts, a list of contacts on a social networking website, a list of friends, or any other list of contacts or users, for example.

Activity notification process 10a-10d may also detect 204, for a member associated with a member identifier in the list of member identifiers, if the member has engaged in recent activity on a website. What is deemed “recent” activity engaged in by a user may be defined by any of plurality of metrics, such as, for example, activities engaged in since a last time such detection was made, activities engaged in within a certain temporal interval, activities engaged in since a certain date and/or time, other metrics, or any suitable combination of the foregoing.

For example, activity notification process 10a-10d may detect 204 whether the member has engaged in activity with a website, such as, for example, a social networking site or blogging site, or any website that allows a user to post. Engaging in an activity may include, for example, posting and/or responding to a blog or microblog entry, adding or updating content in a wiki, joining a community, posting a file in a shared repository, posting comments on a file, updating a profile, posting status information, posting information or content on a social networking site, other activities, or any suitable combination of the foregoing. Activity notification process 10a-10d may detect 204 whether the member has engaged in any type of activity on a website, for example.

If a user engages in activity on a website, then, user preferences of the user may be applied 206, for example, by activity notification process 10a-10d and/or communications application 12a-12d. The user preferences may define whether the user wishes to generate a notification that he/she has engaged in recent activity on the website. For example, user 24 may wish to inform co-workers (or anyone from the user 24's social network and/or with whom user 24 collaborates) whenever user 24 logs into or posts content to a blog site relating to user 24's work. Additionally and/or alternatively, user 24 may wish to shield the same co-workers from receiving notifications that user 24 has logged into or posted content to a social site, such as the Facebook site. Accordingly, activity notification process may allow user 24 to set preferences relating to the notification.

In an embodiment in which recent user activity is detected 206 by a separate entity (e.g., a presence server or other server-side application) from an entity that generates a notification 208 (e.g., a client-side of a communication application and/or activity notification process), the recent activity information may be communicated 207 from the activity-detecting entity to the notification-generating entity. For example, if such entities reside on separate devices (e.g., 22 and 16 respectively), then such communication may be sent across network 20 using any of a variety of known communication techniques.

A notification based on user preferences may be generated 208, for example, by activity notification process 10a-10d. User 24 may set a preference that directs activity notification process 10a-10d to generate 208 a notification for only co-workers whenever user 24 logs into or posts content to the blog site relating to work, for example. User 24 may also set a preference that directs activity notification process 10a-10d to generate 208 a notification for only social contacts whenever user 24 logs into or posts content to a social site, and not when user 24 logs into or posts content to the social site. User 24 may also set preferences to generate 208 notifications that the user engaged in any activity on a website for any user and for any website activity, or may set preferences that do not generate 208 notifications that the user engaged in recent activity on a website, for example. In general, user 24 may set any type of preference that generates 208 or does not generate 208 a notification for any user or group of users, for example.

More generally, user preferences may include preferences specific to groups of users such as, for example, co-workers, social friends, members of an organization, members at a particular level within an organizational hierarchy, certain roles within an organization, other groups, or any suitable combination of the foregoing. These preferences may utilize various sources of information such as, for example, social networks to which a user belongs, a Lightweight Directory Access Protocol (LDAP) directory, a list of contacts within a communication application (e.g., a group within a buddy list of an instant messaging application), other databases, directories and networks, and any suitable combination of the foregoing. For example, a user preference of a user of an instant messaging application may specify that all members of a user-defined group within the user's buddy list are notified or not notified of the user engaging in activity on a particular website. As an another example, a user of a communications application may specify that all users below the user in the hierarchy of an LDAP directory are notified or not notified of the user engaging in activity on a particular website.

The user preferences may also include information about individual members allowed to receive the notification. For example, if user 24 wants user 26 to receive notification of user 24's activity on a website, user 24 may set preferences allowing user 26 to receive a notification. Additionally/alternatively, if user 24 does not want user 26 to receive a notification of user 24's activity on a website, user 24 may set preferences that prohibit user 26 from receiving a notification.

For example, user 24 may set a preference so that a notification is not generated for user 26 when user 24 engages in activity on a website. Accordingly, activity notification process 10b running on user 24's computing device may detect 204 whether member 24 engages in activity on a website. If user 24 engages in activity on the website, activity notification process 10b may communicate with user 26's computer, communication application 12c, and/or activity notification process 10c; and activity notification process 10a-10d may generate 208 a notification through user 26's computing device, through communication application 12c, and/or through activity notification process 10c that user 24 has engaged in activity on the website. However, if user 24 sets a preference so that user 26 does not receive a notification of user 24's activity on a website, activity notification process 10b may not generate 208 a notification through user 26's computing device and/or through activity notification process 10c that user 24 has engaged in activity on the website.

A recipient of the notification that a member engaged in recent activity on a website may also set preferences. For example, assume user 26 receives notifications whenever user 24 logs into or posts content to a website. User 26 may wish to receive only certain notifications about the website activity of user 24. For example, user 26 may wish to receive notifications only when user 24 posts content to an internal work-related blog and not when user 24 logs into a social networking site. Accordingly, user 26 can set a preference such that activity notification process 10a-10d generates 208 a notification when user 24 publishes content to the internal work-related blog, but does not generate 208 a notification when user 24 has logged into a social networking site, for example. In general, user 26 may set any type of preference that generates 208 or does not generate 208 notifications of a member's activity on a website.

For example, user 26 may set a preference to receive a notification when user 24 posts content to a work-related blog, but not when user 24 logs into a social networking site. Accordingly, activity notification process 10c may detect 204 whether member 24 has engaged in recent activity in a website. If user 24 engages in activity on the website, activity notification process 10c may generate 208 a notification through user 26's computing device and/or through communication application 12c that user 24 has engaged in activity on the website. However, if user 26 sets a preference so that user 26 does not receive a notification of user 24's activity on a website, activity notification process 10c may not generate 208 a notification through user 26's computing device and/or through activity notification process 10c that user 24 has engaged in activity on the website.

A recipient of the notification that a member engaged in recent activity on a website may also set preferences specific to groups of users such as, for example, co-workers, social friends, members of an organization, members at a particular level within an organizational hierarchy, certain roles within an organization, other groups, or any suitable combination of the foregoing. These preferences may utilize various sources of information such as, for example, social networks to which a user belongs, a Lightweight Directory Access Protocol (LDAP) directory, a list of contacts within a communication application (e.g., a group within a buddy list of an instant messaging application), other databases, directories and networks, and any suitable combination of the foregoing. For example, a user preference of a recipient may specify that the recipient is notified or not notified of any member of a user-defined group (e.g., within the user's buddy list) engaging in an activity on a particular website. As an another example, the recipient may specify that the recipient is notified or not notified of activity on a particular website engaged in by users below the user in the hierarchy of an LDAP directory.

The user preferences may also include a type of data, which, when posted, generates 208 a notification that the member has engaged in recent activity on a website. For example, user 24 may set preferences so that activity notification process 10a-10d generates 208 a notification when user 24 posts text data and/or audio data to a website, but not when user 24 posts picture data (i.e. JPG, BMP, GIF or other picture data) to a website. One skilled in the art will recognize that a user may set a preference so that activity notification process 10a-10d generates 208, or does not generate 208 a notification based on any type of website activity and/or posted data including, but not limited to: audio data, text data, picture data, video data, file types, log-in/log-out data, website access data, personal data, work-related data, etc.

Notification process 10a-10d may apply 206 user preferences of a user when, for example, content notifications are generated 208. When the user preferences are applied 206, the user preferences may be used to determine which content notifications to generate 208, i.e. generating 208 the notification may be based on the user preferences. For example, if user 26 sets preferences to receive notifications of only work-related content from user 24, then activity notification process 10a-10d may only generate 208 a notification for user 26 when user 24 posts work-related content. Similarly, and in general, activity notification process 10a-10d may use member preferences from a user who posts content, and/or from a user who receives content, to generate 208 and/or not generate 208 a notification of the content.

Users may set preferences in various ways. For example, activity notification process 10a-10d and/or communication application 12a-12d may provide a graphical user interface (GUI) that allows users to set preferences for how they receive notifications of published content. For example, the GUI may allow a user to specify that he/she wants to receive only work-related notifications, only certain types of data, and/or only notifications from a particular user or group of users. The GUI may also allow users to set preferences for how activity notification process 10a-10d generates notification of published content.

User preferences may be stored in a file, memory, or other storage accessible, for example, by activity notification process 10a-10d and/or communication application 12a-12d. User preferences may also be incorporated into a presence document, a section of a presence document, an extension of a presence document and/or elements within a presence document. Presence documents will be discussed below in greater detail.

When it is detected 204 if a member engaged in recent activity on a website, activity notification process 10a-10d may generate 208 a notification indicating that the member engaged in recent activity. If allowed by the user preferences, notification process 10a-10d may communicate to a process running on a computing device of at least one other user of the communication application. The communication may include information that the user has engaged in activity on the website. In some embodiments, the acts of applying 206 the user preferences and communicating to a process running on a computing device may be performed by a server of an instant messaging application.

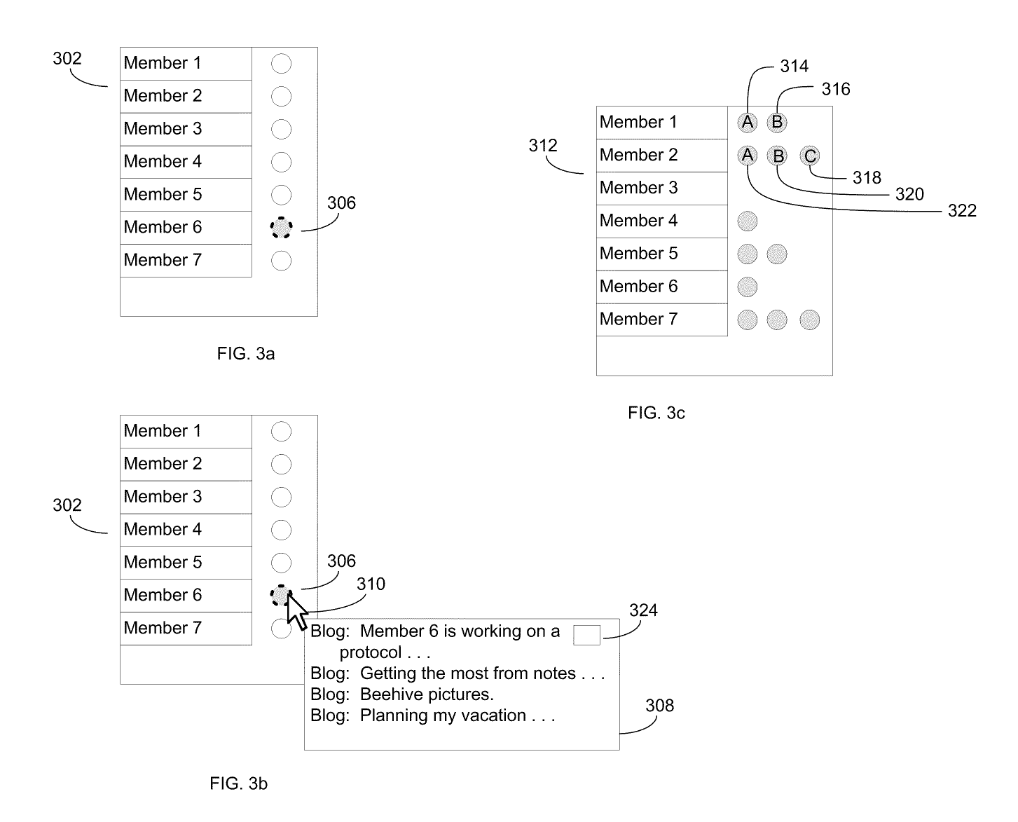

Communication process 10a-10d may generate 208 a notification indicating that the member engaged in the activity. The notification may, for example, be displayed in proximity to the list of member identifiers, e.g., in proximity to, a buddy list, contact list, or any list of contacts. FIG. 3a depicts one example of a notification. FIG. 3a shows buddy list 302, which may be a list of member identifiers, such as instant messaging contacts, email contacts, friends, or other contacts. In this example, the member identifiers may identify members 1-7. Each of these users (i.e. members 1-7) may publish content to a social networking site, for example, or may otherwise engage in activity on a website.

Activity notification process 10a-10d may also associate 210 a respective icon with at least one member identifier. In one example, activity notification process 10a-10d may associate 210 a single icon with at least one member identifier. For example, buddy list 302 may include an icon associated 210 with each member identifier in buddy list 302. Icon 304 may be associated 210 with member identifier “Member 1,” and icon 306 may be associated 210 with member identifier “Member 6.” In this example, Member 6 may have published content to a social networking and/or blogging site, or may have otherwise engaged in recent activity on a website. Accordingly and as shown, activity notification process 10a-10d may generate 208 a notification that Member 6 engaged in recent activity on a website. In this example, activity notification process 10a-10d may have generated 208 a notification by changing 212 a visual attribute of the icon. For example, activity notification process 10a-10d may have changed 212 the brightness and/or color of icon 306 to indicate that Member 6 has published content to a social networking site, as shown in FIG. 3a. A user viewing buddy list 302 may see the change in visual appearance (e.g., in color or brightness) of icon 306 and may be notified that Member 6 has published content. Of course, as discussed above, activity notification process 10a-10d may generate 208 the notification and change 212 the color or brightness of icon 306, or not generate 208 the notification, based Member 6's user preferences or the user preferences of the user viewing buddy list 302.

Referring to FIGS. 2 and 3b, activity notification process 10a-10d may display 214, within or in proximity to the notification, at least a portion of the content posted to the website by the member. Activity notification process 10a-10d may, for example, provide a preview of the published content for a user to view. For example, FIG. 3b shows pop-up box 308 which may contain and/or display 214 a portion of the content published by Member 6. Pop-up box 308 may be displayed 214 within or in proximity to icon 306 and/or a notification that Member 6 has engaged in activity on a website. In this example, Member 6 may have published four blog entries. When a user hovers on-screen pointer 310 over icon 306, for example, activity notification process 10a-10d may display pop-up box 308. Pop-up box 308 may include a portion of each of Member 6's blog entries. In this example, pop-up box 308 may show text entries stating: “Member 6 is working on a protocol,” “Getting the most from Notes,” “Beehive pictures,” and “Planning my vacation.” These text entries may be a portion or summary of blog entries Member 6 published on a website, such as a social networking or blogging site. Activity notification process 10a-10d may also display 214 other information related to a member's activity on a website. For example, if Member 6 logged into a website, activity notification process 10a-10d may generate 208 a notification and/or display 214 a notice in pop-up box 308 that informs a user that Member 6 logged into a website, for example. Displaying 210 a portion of a member's recent activity on a website and/or content posted to a website may allow a user to preview the member's posted content and/or follow the member's website activity.

FIG. 3c shows another example of a list of member identifiers within a buddy list. In FIG. 3c, activity notification process 10a-10d may associate 210 an icon with each website identified in user preferences of the member. For example, buddy list 312 shows various numbers of icons associated 210 with the member identifiers. In buddy list 312, Member 1 may have two associated 210 icons, Member 2 may have three associated 210 icons, member 3 may have zero associated 210 icons, etc. Each icon may also be associated with a website identified in the member's user preferences. For example, Member 1 may have user preference settings that instruct activity notification process 10a-10d to generate 208 a notification when member 1 engages in activity on website A and website B. As shown, icon 314 may be associated with website A (as indicated by the letter “A” within icon 314), and icon 316 may be associated with website B (as indicated by the letter “B” within icon 316). Member 2 may have user preference settings that instruct activity notification process 10a-10d to generate 208 a notification when member 2 engages in activity on website A, website B, and/or website C, as shown by icons 318, 320, 322. Member 3 may have user preference settings that instruct activity notification process 10a-10d not to generate 208 a notification. Accordingly, activity notification process 210 may display zero icons associated 210 with member 3.

When member 1 engages in activity on website A, activity notification process 10a-10d may generate 208 a notification via icon 314 because icon 314 may be associated with website A. Similarly, if member 1 engages in activity on website B, activity notification process 10a-10d may generate 208 a notification via icon 316 because icon 316 may be associated with website B. Activity notification process 10a-10d may, for example, change 212 a visual attribute of icon 314 or icon 316 such as changing 212 a color and/or brightness of icon 314. Also, if a user hovers an on-screen pointer over icon 314 or icon 316, activity notification process 10a-10d may display 214 a portion of member 1's website activity within or in proximity to icon 314 and/or icon 316.

Activity notification process 10a-10d may also indicate the age of a member's recent activity on a website by changing 212 a visual attribute of an icon. For example, if member 1's activity on website A was very recent, activity notification process 10a-10d may display icon 314 as very bright. If member 1's activity on website B is relatively old, activity notification process 10a-10d may display icon 316 relatively dimly. Additionally/alternatively, activity notification process 10a-10d may use colors to indicate the recentness of a member's activity on a website. For example, activity notification process 10a-10d may display icon 314 in one color if member 1's activity on website A is recent, and in another color if member 1's activity on website A is relatively old. Activity notification process 10a-10d may also indicate the recentness of member 1's activity by using grades of brightness and/or colors. For example, the level of brightness may be very bright for new posts, somewhat bright for older posts, and dim for the oldest posts. Additionally/alternatively, the color may be one color for new posts, another color for older posts, and yet another color for the oldest posts.

Activity notification process 10a-10d may also display 216, within or in proximity to the notification, a link to the website or a particular location therein. Turning to FIG. 3b, activity notification process 10a-10d may display 216 link 324 to a website where member 6 was recently active. Link 324 may be a button, a text box, or any other feature that provides a link to a website. Link 324 may also be incorporated into text displayed on a screen, a pop-up box, etc. In general, link 324 may be displayed in, or incorporated into, any type of GUI feature.

Link 324 may also provide the address of the website where member 6 recently posted content, for example. If a user clicks link 324, activity notification process 10a-10d and/or a web browser may open the website, or a portion thereof, where member 6 posted content or otherwise engaged in activity.

Turning also to FIG. 3c, activity notification process 10a-10d may display 216 a link within or in proximity to icon 314, for example. If member 1 has engaged in recent activity on website A, activity notification process 10a-10d may display 216 a link to website A, and/or a link to the activity on website A. If a user clicks icon 314 or hovers an on-screen pointer of icon 314, for example, activity notification process 10a-10d may open website A or the portion of website A that includes the recent activity.

Activity notification process 10a-10d may detect 204 if a member has engaged in any recent activity on a website by monitoring 218 the website. Activity notification process 10a-10d may, for example, monitor 218 the website for activity by the member. Monitoring 218 the website may include periodically and/or automatically accessing the website to detect 204 whether the member has recently logged into the website, posted content to the website, etc. Activity notification process 10a-10d may access the website and read and/or parse the contents of the website and/or metadata from the website to determine if the member has engaged in recent activity on the website.

Activity notification process 10a-10d may also collect 220 information from the website. The information may include information about whether the member has engaged in recent activity on the website, an address of the website or a location at which the member engaged in activity, a date and/or time at which the member engaged in activity, and/or any content associated with the activity. Activity notification process 10a-10d may collect 220 the information by actively polling the website. For example, activity notification process 10a-10d may periodically and/or automatically monitor 218 the website, as discussed above. Activity notification process 10a-10d may also request the information from the website. If activity notification process 10a-10d requests the information from the website, the website may provide the information to activity notification process 10a-10d in response to the request. Additionally/alternatively, the website may periodically send the information to activity notification process 10a-10d, which may be configured to listen for and/or periodically receive and/or collect 220 the information from one or more websites.

Applying 206 user preferences may also include interpreting 222 a presence document associated with the member, for example, if the user preferences, in whole or in part, are stored in the presence document. Interpreting 222 a presence document may be performed by application notification process 10a-10d and/or communication application 12a-12d. For example, a presence server may interpret the presence, e.g., as part of an instant messaging application. As known in the art, a presence document may be a file or data structure that contains information about a user's online presence. The information in a presence document may include whether a user is currently online, currently available, currently busy, currently offline, etc. In some cases, a presence document may be an XML document or data structure and may adhere to a particular XML schema. For example, a presence document may follow the Presence Information Data Format (“PIDF”) standard, which may define a format for presence documents. The PIDF may specify XML elements and/or attributes relating to the presence of a user, such as a “presence” element, a “tuple” element, a “status” element, a “note” element, a “contact” element, and the like.

The presence document may be modified, for example, to contain information about whether the member has engaged in recent activity. For example, the presence document may be extended to include information such as: whether the member engaged in recent activity on a website, whether the member posted content on a website, the address of a website where the user engaged in activity, a date and/or time the user engaged in activity on a website, a link to a website where the user engaged in activity, content posted to the website by the user or a portion thereof, and/or any other information related to the members activity on a website.

The information in the presence document relating to a member's recent activity on a website may be an extension of the presence document. For example, the information may be included in an extra section and/or extra elements in the presence document that are extraneous to the standard format of a presence document; the extra section and/or extra elements may be additions to the presence document. Additionally or alternatively, the information may be included within fields already defined in a standard format of the presence document. For example, if the presence document contains a field for “notes” or “other information,” the information about whether a member engaged in recent activity on a website may be contained in the “notes” or “other information” fields.

Activity notification process 10a-10d may interpret 222 and/or read the presence document to detect 204 if the member engaged in recent activity on a website. If the information included in the presence document indicates that the member engaged in recent activity, activity notification process 10a-10d may generate 204 a notification, as discussed above, for example.

The methods and computer program products claimed may be used, for example, to create a notification of a user's activity on one or more websites. A number of implementations have been described. Nevertheless, it will be understood that various modifications may be made. Accordingly, other implementations and other uses are within the scope of the following claims.

Having now described some illustrative embodiments of the invention, it should be apparent to those skilled in the art that the foregoing is merely illustrative—and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A computer program product residing on one or more computer-readable storage media, having a plurality of instructions, which, when executed by a processor, cause the processor to perform operations comprising:
generating a list of one or more member identifiers on a computer display; and
for a member associated with at least one member identifier in the list of one or more member identifiers, if allowed by user preferences of the member, generating on the computer display a notification indicative of a recent activity engaged in by the member on a website such that the notification is associated with the at least one member identifier.

2. The computer program product of claim 1, wherein the operations further comprise:
for the at least one member identifier, detecting if the member has engaged in any recent activity on a website; and
if it is detected that the member has engaged in any recent activity on the website, applying the user preferences of the member.

3. The computer program product method of claim 1, wherein the user preferences specify one or more members and/or groups of members allowed to receive the notification.

4. The computer program product of claim 1, wherein the user preferences specify one or more websites for which a notification should be generated.

5. The computer program product of claim 1, wherein the user preferences specify one or more types of activities for which a notification should be generated.

6. The computer program product of claim 1, wherein the list of member identifiers comprises one or more of:
an instant messaging buddy list providing a notification of whether the member is currently online;
an email contact list; and
an address book.

7. The computer program product of claim 1, wherein the operations further comprise:
interpreting a presence document of the member, the presence document including data indicating whether the member engaged in recent activity on a website.

8. The computer program product of claim 1, wherein generating the notification further comprises one or more of:
displaying at least a portion of content posted to the website by the member; and
displaying a link to the website or a particular location therein.

9. The computer program product of claim 1, wherein generating the list comprises associating a respective icon with the at least one member identifier, and
wherein, if it is detected that the member has engaged in any recent activity on the website, generating the notification comprises changing a visual attribute of the icon associated with the at least one member identifier.

10. A computer program product residing on one or more computer-readable storage media, having a plurality of instructions, which, when executed by a processor, cause the processor to perform operations comprising:
detecting that a user of a communication application engages in an activity on a website, applying user preferences of the user; and
if allowed by the user preferences, communicating to a process running on a computing device of at least one other user of the communication application that the user has engaged in the activity.

11. The computer program product of claim 10, wherein the user engaging in an activity is recorded in a presence document of the user.

12. The computer program product of claim 10, wherein the acts of applying and communicating are performed by a server of an instant messaging application.

13. The computer program product of claim 10, wherein the act of communicating includes communicating at least a portion of content on the website resulting from the user engaging in the activity.

14. The computer program product of claim 10, wherein the user preferences specify one or more members and/or groups of members allowed to receive the notification.

15. The computer program product claim 10, wherein the user preferences specify one or more websites for which a notification should be generated.

16. A computer-implemented method, comprising:
detecting that a user of a communication application engages in an activity on a website, applying user preferences of the user; and
if allowed by the user preferences, communicating to a process running on a computing device of at least one other user of the communication application that the user has engaged in the activity.

17. The computer-implemented method of claim 16, wherein the user engaging in an activity is recorded in a presence document of the user.

18. The computer-implemented method of claim 16, wherein the acts of applying and communicating are performed by a server of an instant messaging application.

19. The computer-implemented method of claim 16, wherein the act of communicating includes communicating at least a portion of content on the website resulting from the user engaging in the activity.

20. The computer-implemented method of claim 16, wherein the user preferences specify one or more types of activities for which a notification should be generated.
